(19) United States
(12) Patent Application Publication
(10) Pub. No.: US 2020/0213753 A1
(43) Pub. Date: Jul. 2, 2020

(54) Loudspeaker

(71) Applicant: AAC Technologies Pte. Ltd., Singapore City (SG)

(72) Inventors: Chengming Cao, Shenzhen (CN); Bo Xiao, Shenzhen (CN)

(21) Appl. No.: 16/705,197

(22) Filed: Dec. 5, 2019

(30) Foreign Application Priority Data
Dec. 27, 2018 (CN) 201822227965.0

(51) Int. Cl. H04R 9/06; H04R 7/12; H04R 9/02

(52) U.S. Cl. CPC H04R 9/06; H04R 7/127; H04R 7/18; H04R 2400/11; H04R 9/025

(57) ABSTRACT

The invention provides a loudspeaker, including: a frame; a vibration structure supported by the frame; a magnetic circuit structure carried by the frame; and a back cavity formed cooperatively by the frame, the vibration structure and the magnetic circuit structure. A number of leakage holes is formed in the frame for communicating the back cavity and outside of the loudspeaker. The loudspeaker further includes a number of corresponding filling pieces received in the leakage holes and made of sound adsorption material.

### FIELD OF THE PRESENT DISCLOSURE

The present disclosure relates to the field of electroacoustic transducers, more particularly to a loudspeaker used in a mobile electronic device.

### DESCRIPTION OF RELATED ART

With the arrival of the mobile internet era, the number of intelligent mobile equipment rises continuously. In a plurality of mobile equipment, the mobile phone is undoubtedly the most common, most portable mobile terminal equipment. At present, the functions of the mobile phone and the functions of the mobile phone are various. One of the functions of the mobile phone is a high-quality music function, and a loudspeaker, in the mobile phone is one of the necessary component for achieving the high-quality music performance.

A loudspeaker in a related art generally comprises a housing with a cavity, a vibration structure and a magnetic circuit structure. The vibration structure and the magnetic circuit structure are arranged in the cavity of the housing and divide the cavity into a front cavity and a rear cavity. The rear cavity is generally a sealed cavity. Because of the sealed cavity, the vibration of the vibration structure can be affected, and the acoustic performance of the loudspeaker is affected.

Therefore, it is necessary to provide an improved loudspeaker to solve the problems mentioned above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a loudspeaker in accordance with an exemplary embodiment of the present disclosure.

FIG. 2 is an exploded view of the loudspeaker.

FIG. 3 is a cross-sectional view of the loudspeaker in FIG. 1, taken along A-A.

FIG. 4 is an isometric and cross-sectional view of the loudspeaker.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

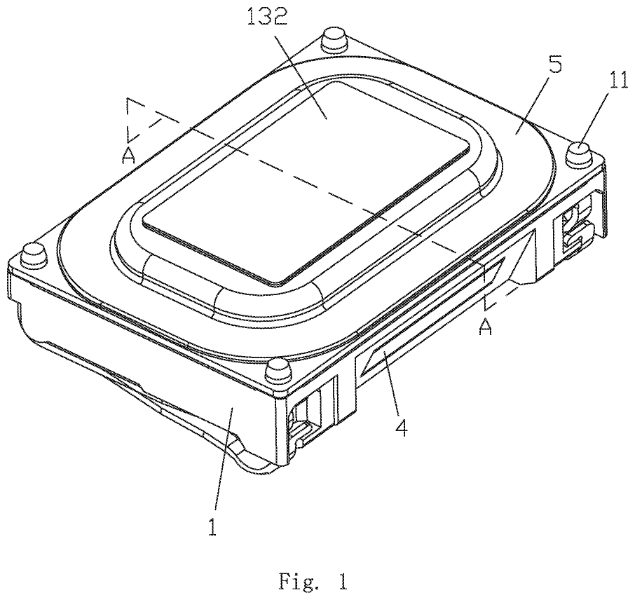

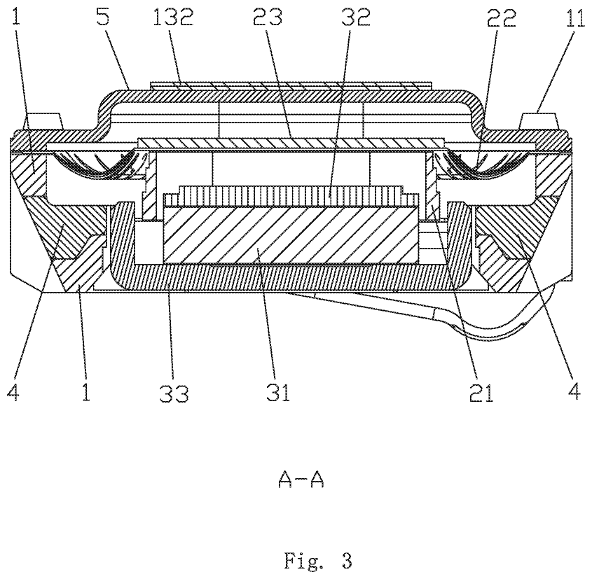

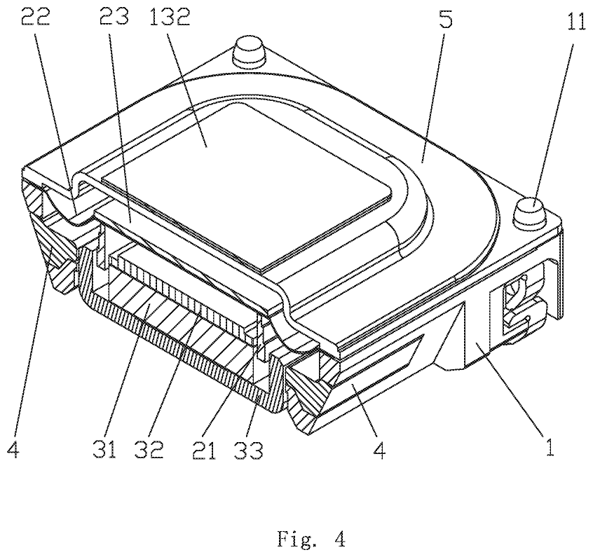

Referring to FIGS. 1-4, a loudspeaker, in accordance with an exemplary embodiment of the present invention, comprises a frame 1, a vibrating structure 2 fixed to the frame 1, and a magnetic circuit structure 3. The vibrating structure 2, the magnetic circuit structure 3 and the frame 1 cooperatively form a rear cavity of the loudspeaker. A leakage hole 111 communicated with the rear cavity and the outside is formed in the frame 1. A filling piece 4 is arranged in the leakage hole 111 and is matched with the leakage hole 111. The filling piece 4 is made of a sound absorbing material.

The filling piece 4 is arranged in the leakage hole 111 in the frame 1, and is made of sound absorbing materials, which performs the functions of dust prevention and sound resistance adjustment. Meanwhile, the lowest resonance frequency of the rear cavity can be adjusted, so that, the f₀ of the loudspeaker is adjusted. Accordingly, better acoustic performance is obtained.

An upper cover 5 is arranged on the frame 1, and a front cavity opposite to the rear cavity is therefore formed between the vibration structure 2 and the upper cover 5. The magnetic circuit structure 3 includes a magnet 31, a pole plate 32, and a magnetic yoke 33. The magnetic yoke 33 includes a base plate 331, and a side plate 332 protruding from a peripheral side of the base plate 331. When the magnetic yoke 33 is assembled with the frame 1, the side plate 332 extends into the rear cavity. The magnet 31 is assembled with the base plate 331; and the pole plate 32 is assembled with one side of the magnet 31 far away from the base plate 331.

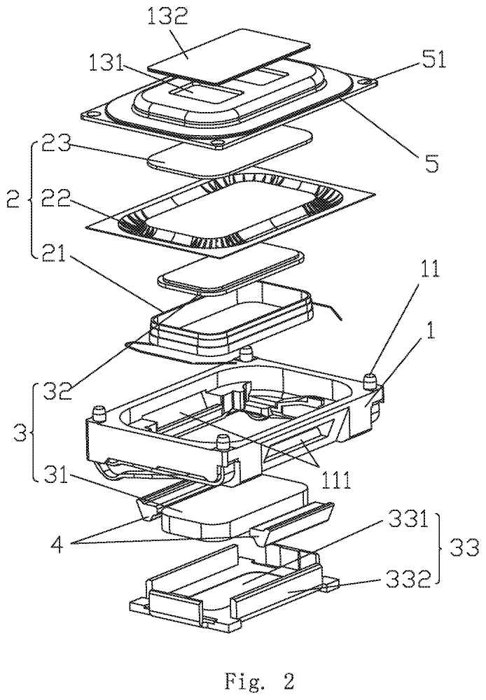

Specifically, as shown in FIGS. 2-4, in the embodiment, the frame 1 is in a rectangular shape, and the base plate 331 is a rectangular board. Each of the four edges of the base plate 331 connects with one side plate 332. The magnet 31 is assembled on the base plate 331. The pole plate 32 is assembled on one side of the magnet 31 far away from the base plate 331. The side plates 332 surrounds the magnet 31 for forming a magnetic gap therebetween.

The vibration structure 2 comprises a voice coil 21, a diaphragm 22 and a dome 23. The voice coil 21 is suspended in the magnetic gap and surrounds the magnet 31. The diaphragm 22 is connected to an end of the voice coil 21 far away from the base plate 331. An edge of the diaphragm 22 is fixed by the frame 1.

At least one leakage hole 111 is formed in the peripheral side of the frame 1. In the embodiment, each of the two opposite sides of the frame 1 is respectively provided with one leakage hole 111. Each of the leakage hole 111 receives a filling piece 4 therein. In this embodiment, the frame 1 is in a rectangular shape with two long axis sides, and, each of the long axis sides is provided with a leakage hole 111. The leakage hole 111 is communicated with the rear cavity. Optionally, the leakage hole 111 is rectangular. The filling piece 4 is arranged in the leakage hole 111, and extends towards the back cavity to fill a part of the rear cavity. The filling piece 4 is made of sound absorption materials, such as fibrous or granular. Optionally, the frame 1 is in a rectangular shape. Two long side edges of the frame 1 can be respectively provided with two, three, four, five and other number of leakage holes 111. The leakage holes 111 can be round, triangular, quadrilateral, pentagonal, hexagon and the like. Corresponding filling pieces 4 are arranged in the leakage holes 111. In other embodiments, the four side edges of the frame 1 can be provided with leakage holes 111. In other embodiments, the frame 1 may also be a frame shaped like a circle, a triangle, a square shape, a pentagon, a hexagon, etc. The periphery of the frame 1 is provided with one, two, three, four and other leakage holes 111, the shape of the leakage hole 111 can be circular, triangular, quadrilateral, pentagonal, hexagon and the like, and corresponding filling pieces 4 are arranged in the leakage hole 111.

A top side of the frame 1 is provided with a clamping protrusion 11, while the upper cover 5 is provided with a clamping hole 51 corresponding to the clamping protrusion 11. The clamping hole 51 is engaged with the clamping protrusion 11. The upper cover 5 is buckled and assembled with the frame 1. Two sound outlet holes 131 are formed in the upper cover 5 for communicating with the front cavity. A dust cap 132 is arranged on the upper cover 5, and the dust cap 132 covers the sound outlet hole 131 for dust prevention.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A loudspeaker, comprising:
a frame;
a vibration structure supported by the frame;
a magnetic circuit structure carried by the frame;
a back cavity formed cooperatively by the frame, the vibration structure and the magnetic circuit structure;
a plurality of leakage holes formed in the frame for communicating the back cavity and outside of the loudspeaker;
a plurality of corresponding filling pieces received in the plurality of leakage holes and made of sound adsorption material.

2. The loudspeaker as described in claim 1 further comprising a top cover engaging with the frame, and a front cavity formed between the vibration structure and the top cover, wherein the front cover is opposite to the back cavity.

3. The loudspeaker as described in claim 2, wherein at least one of the leakage holes is formed in a periphery of the frame.

4. The loudspeaker as described in claim 3, wherein the frame includes a pair of opposite sides, and each of the sides is provided with at least one of the leakage holes.

5. The loudspeaker as described in claim 1, wherein the filling piece extends into the back cavity.

6. The loudspeaker as described in claim 1, wherein the magnetic circuit structure includes a magnet, a pole plate attached to a top of the magnet, a magnetic yoke having a base plate for carrying the magnet and a side plate extending perpendicularly from edges of the base plate; the side plates extend into the back cavity when the magnetic yoke is assembled with the frame; and wherein the top of the magnet is far away from the base plate.

7. The loudspeaker as described in claim 6, wherein the vibration structure includes a voice coil surrounding the magnet, a diaphragm connecting with one end of the voice coil far away from the base plate, and a dome attached to one side of the diaphragm away from the voice coil.

8. The loudspeaker as described in claim 2, wherein the top cover is provided with at least one sound outlet for communicating with the front cavity.

9. The loudspeaker as described in claim 8 further including a dust cap engaging with the top cover for covering the sound outlet.

10. The loudspeaker as described in claim 2, wherein a top side of the frame is provided with a clamping protrusion, while the upper cover is provided with a clamping hole engaging with and corresponding to the clamping protrusion.
